(19) United States
(12) Patent Application Publication
(10) Pub. No.: US 2017/0147855 A1
(43) Pub. Date: May 25, 2017

(54) FINGERPRINT SENSING MODULE

(71) Applicant: GINGY TECHNOLOGY INC., HSINCHU (TW)

(72) Inventor: Jen-Chieh Wu, Hsinchu City (TW)

(21) Appl. No.: 15/145,809

(22) Filed: May 4, 2016

Related U.S. Application Data
(60) Provisional application No. 62/258,519, filed on Nov. 22, 2015.

(30) Foreign Application Priority Data
Jan. 19, 2016 (TW) 105101494

(51) Int. Cl. G06K 9/00; H04N 5/335; G06K 9/20

(52) U.S. Cl. CPC G06K 9/00053; G06K 9/00087; G06K 9/2027; H04N 5/335

(57) ABSTRACT

A fingerprint sensing module includes a sensing unit having a sensing surface, a light source arranged beside the sensing unit, and an optical covering film arranged on the sensing unit. The optical covering film covers the sensing surface. The optical covering film includes a touching surface and a connecting surface opposite to the touching surface. The touching surface is suitable for being in touch with a finger of a user, and the connecting surface is connected to the sensing surface. A refractive index of the optical covering film increases from the connecting surface to the touching surface. The light source is suitable for emitting light to the touching surface, so as to irradiate the finger of the user.

### CROSS-REFERENCE TO RELATED APPLICATION

This application claims the priority benefits of U.S. provisional application Ser. No. 62/258,519, filed on Nov. 22, 2015 and Taiwan application serial no. 105101494, filed on Jan. 19, 2016. The entirety of each of the above-mentioned patent applications is hereby incorporated by reference herein and made a part of this specification.

### TECHNICAL FIELD

The disclosure relates to a sensing apparatus and more particularly to a fingerprint sensing module.

### DESCRIPTION OF RELATED ART

According to the conventional identification technology, fingerprint identification is done by pressing one's finger onto an ink pad and rolling the finger onto paper to generate an image of the fingerprint, for instance, and the fingerprint undergoes optical scan and is input to a computer and is archived, so that the fingerprint of record can be applied for comparison. Nevertheless, the above fingerprint identification method cannot be instantaneously applied and fails to comply with the current requirement for instantly authenticate the identities of people. Accordingly, electronic fingerprint sensing apparatuses have become one of the mainstream products at present.

### SUMMARY OF THE DISCLOSURE

The disclosure provides a fingerprint sensing module capable of achieving favorable identification effects and protection effects.

In an embodiment of the disclosure, a fingerprint sensing module is suitable for sensing a fingerprint of a finger of a user and includes a sensing unit having a sensing surface, a light source arranged beside the sensing unit, and an optical covering film arranged on the sensing unit. The optical covering film covers the sensing surface. The optical covering film includes a touching surface and a connecting surface opposite to the touching surface. The touching surface is suitable for being in touch with the finger of the user, and the connecting surface is connected to the sensing surface. A refractive index of the optical covering film increases from the connecting surface to the touching surface. The light source is suitable for emitting light to the touching surface, so as to irradiate the finger of the user.

According to an embodiment of the disclosure, the optical covering film includes a plurality of optical layers. The optical layers are stacked on the sensing surface along a normal vector of the sensing surface, and refractive indices of the optical layers are different. The refractive indices of the optical layers close to the touching surface are greater than the refractive indices of the optical layers close to the connecting surface.

According to an embodiment of the disclosure, one or more interfaces parallel to each other are formed between the optical layers, and the one or more interfaces are parallel to the sensing surface.

According to an embodiment of the disclosure, a material of the optical layers includes a thermosetting material or a light curable material.

According to an embodiment of the disclosure, the touching surface is a smooth plane.

According to an embodiment of the disclosure, the light source and the sensing unit are arranged on a side of the optical covering film adjacent to the connecting surface, and the connecting surface is suitable for receiving the light emitted by the light source.

According to an embodiment of the disclosure, the optical covering film exposes the light source.

According to an embodiment of the disclosure, the sensing unit is an image sensor.

According to an embodiment of the disclosure, the number of the light source is plural, and the light sources are arranged on a side of the sensing unit, on a corner of the sensing unit, or on both the side and the corner of the sensing unit.

According to an embodiment of the disclosure, the touching surface and the connecting surface are parallel to the sensing surface.

In view of the above, the sensing module provided in an embodiment of the disclosure includes the sensing unit and the optical covering film arranged on the sensing surface of the sensing unit, and the refractive index of the optical covering film increases from the sensing surface to the touching surface; hence, the reflected light from each location on the finger of the user can be received in an accurate manner, and satisfactory sensing effects can be accomplished.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the invention and, together with the description, serve to explain the principles of the disclosure.

FIG. 1A is a schematic cross-sectional view illustrating a fingerprint sensing module according to a first embodiment of the disclosure.

FIG. 1B is a schematic partial enlarged view illustrating an area A depicted in FIG. 1A.

FIG. 2 is a schematic cross-sectional view illustrating a fingerprint sensing module according to a second embodiment of the disclosure.

### DETAILED DESCRIPTION OF DISCLOSED EMBODIMENTS

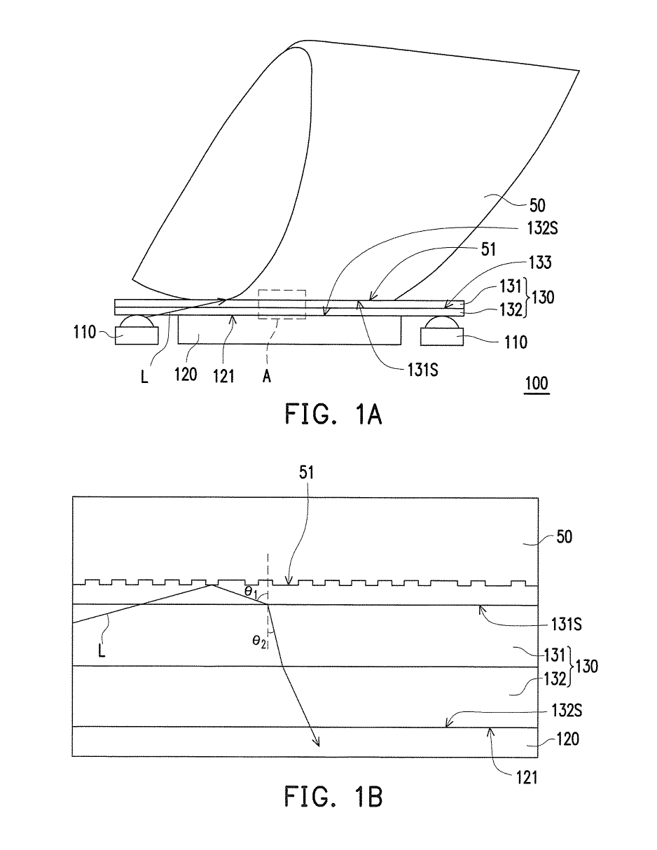

In an embodiment of the disclosure, the fingerprint sensing module is suitable for sensing and identifying the fingerprint of a finger of a user and thereby generates an electrical signal corresponding to the fingerprint of the finger of the user. FIG. 1A is a schematic cross-sectional view illustrating a fingerprint sensing module according to a first embodiment of the disclosure. The fingerprint sensing module 100 provided herein is suitable for capturing an image of a fingerprint of a surface 51 of a finger of the user 50.

With reference to FIG. 1A, the fingerprint sensing module 100 provided in the present embodiment includes a light source 110, a sensing unit 120, and an optical covering film 130. The light source 110 is located beside the sensing unit 120 having a sensing surface 121, and the optical covering film 130 suitable for transmitting light is arranged on the sensing unit 120 and covers the sensing surface 121.

The optical covering film 130 includes a touching surface 131S and a connecting surface 132S opposite to the touching surface 131S. The touching surface 131S is suitable for being in touch with the finger of the user 50, such that the surface 51 of the finger of the user 50 can touch the touching surface 131S. The light source 110 emits light L suitable for being transmitted to the touching surface 131S, so as to irradiate the surface 51 of the finger of the user 50. The optical covering film 130 is connected to the sensing surface 121 through the connecting surface 132S, such that the optical covering film 130 can be placed on the sensing unit 120. In the present embodiment, the optical covering film 130 is suitable for transmitting light, and a refractive index of the optical covering film 130 increases from the connecting surface 132S to the touching surface 131S. That is, the refractive index of the optical covering film 130 gradually decreases from the touching surface 131S to the sensing surface 121S, and thereby a refractive index of the material of the touching surface 131S is greater than a refractive index of the material of the connecting surface 132S.

Since the sensing unit 120 provided in the present embodiment is covered by the optical covering film 130, and the refractive index of the optical covering film 130 increases from the connecting surface 132S to the touching surface 131S, the optical covering film 130 is suitable for receiving the light L emitted from the light source 110. The light L emitted from the light source 110 enters the optical covering film 130 through the connecting surface 132S with the relatively low refractive index, and thus the optical covering film 130 is able to efficiently receive the light L from the connecting surface 132S and further irradiate the surface 51 of the finger of the user 50 located on the touching surface 131S.

In another aspect, the touching surface 131S of the optical covering film 130 has the relatively high refractive index, and thus the fingerprint sensing module 100 is able to accurately sense the image of the fingerprint of the surface 51 of the finger on the touching surface 131S. FIG. 1B is a schematic partial enlarged view illustrating an area A depicted in FIG. 1A. With reference to FIG. 1B, the touching surface 131S is suitable for receiving the light reflected by the surface 51 of the finger of the user 50; since the refractive index of the optical covering film 130 close to the touching surface 131S is relatively high, the refractive angle of the light L passing through the touching surface 131S is relatively small, and the lateral displacement of the light L can then be reduced.

For instance, with reference to FIG. 1B, when the light L passes through the touching surface 131S of the optical covering film 130 at an incident angle θ₁ according to the present embodiment, the refractive angle θ₂ of the light L is much smaller than the incident angle θ₁, and thus the lateral displacement of the light L can then be reduced. Namely, during the transmission of the light L, the optical covering film 130 is conducive to achieving optical collimating effects, such that the image of the fingerprint can be projected onto the sensing surface 121 in an accurate manner.

Besides, the refractive index of the optical covering film 130 close to the connecting surface 132S is relatively low according to the present embodiment, and hence the transmittance of the light L between the optical covering film 130 and the sensing unit 120 can be further improved. The refractive index of the optical covering film 130 decreases from the touching surface 131S to the connecting surface 132S, and thus the optical covering film 130 allows the transmittance of the light L between the optical covering film 130 and the sensing unit 120 to be further improved. The refractive index of the optical covering film 130 close to the connecting surface 132S is similar to the refractive index of the sensing surface 121 of the sensing unit 120; hence, the transmittance of the interface in the optical covering film 130 and the transmittance of the interface between the optical covering film 130 and the sensing unit 120 are relatively high, so as to enhance the efficiency of receiving the light L by the sensing unit 120.

To be specific, the optical covering film 130 provided in the first embodiment includes optical layers 131 and 132, the touching surface 131S is formed on the optical layer 131, and the connecting surface 132S is formed on the optical layer 132. The optical layers 131 and 132 are stacked on the sensing surface 121 along the normal vector of the sensing surface 121, and the refractive index of the optical layer 131 close to the touching surface 131S is greater than the refractive index of the optical layer 132 close to the connecting surface 132S. Hence, when the user 50 places his or her finger on the touching surface 131S of the fingerprint sensing module 100, the optical covering film 130 is located between the touching surface 131S and the connecting surface 132S, and the optical layer 132 with the relatively low refractive index can perform the anti-reflection function between the light source 110 and the optical layer 131. After the light L is reflected by the surface 51 of the finger, the optical layer 131 with the relatively high refractive index can perform the light collimating function between the finger and the optical layer 132, and the optical layer 132 with the relatively low refractive index can perform the anti-reflection function between the optical layer 131 and the sensing unit 120. As such, the fingerprint sensing module 100 provided in the present embodiment is suitable for capturing an image of a fingerprint of the user 50.

In particular, according to the present embodiment, the fingerprint sensing module 100 includes a plurality of light sources 110 arranged on the side, the corner, or the peripheries of the sensing unit 120 or arranged on all of the above, such that the light can adequately irradiate the surface 51 of the finger on the touching surface 131S. The wavelength of the light L emitted from the light sources 110 falls within the range from 640 nanometers (nm) to 940 nm according to the present embodiment, which should however not be construed as a limitation in the disclosure.

In the present exemplary embodiment, the touching surface 131S of the optical covering film 130 is a smooth surface. Hence, the optical covering film 130 can further prevent scratches and better protect the sensing unit 120.

Particularly, the light sources 110 and the sensing unit 120 are arranged on a side of the optical covering film 130 adjacent to the connecting surface 132S, and the connecting surface 132S is suitable for receiving the light L emitted by the light sources 110. In the present embodiment, the light sources 110 are suitable for emitting the light L to the connecting surface 132S of the optical covering film 130; since the optical layer 132 has the relatively low refractive index, the light L can easily penetrate the connecting surface 132S and irradiate the surface 51 of the finger on the touching surface 131S.

In the optical covering film 130 provided in the present embodiment, the touching surface 131S and the connecting surface 132S are parallel to the sensing surface 121. In consideration of the variations in the refractive index of the optical covering film 130, the optical covering film 130 is conducive to the significant improvement of the accuracy of sensing the fingerprint by the fingerprint sensing module 100.

An interface 133 parallel to the sensing surface 121 is formed between the optical layers 131 and 132 according to the present embodiment, and thus the transmission path of the light L in the optical covering film 130 can be adjusted according to the refractive indices of the optical layers 131 and 132. Namely, the refractive index of the optical covering film 130 is changed along the normal vector of the sensing surface 121; hence, when the light L reflected by the surface 51 of the finger enters the optical covering film 130 from the touching surface 131S, the light L can be accurately transmitted to a corresponding location on the sensing surface 121.

The sensing unit 120 provided in the present embodiment is an image sensor. In particular, the sensing unit described herein may be formed by a charged-coupled device (CCD) or a complementary metal-oxide semiconductor (CMOS), which should however not be construed as a limitation in the disclosure.

The optical covering film of the fingerprint sensing module is not limited to the optical covering film 130 made by two optical layers 131, 132 according to the previous embodiment; the optical covering film may also be made by one or more optical layers.

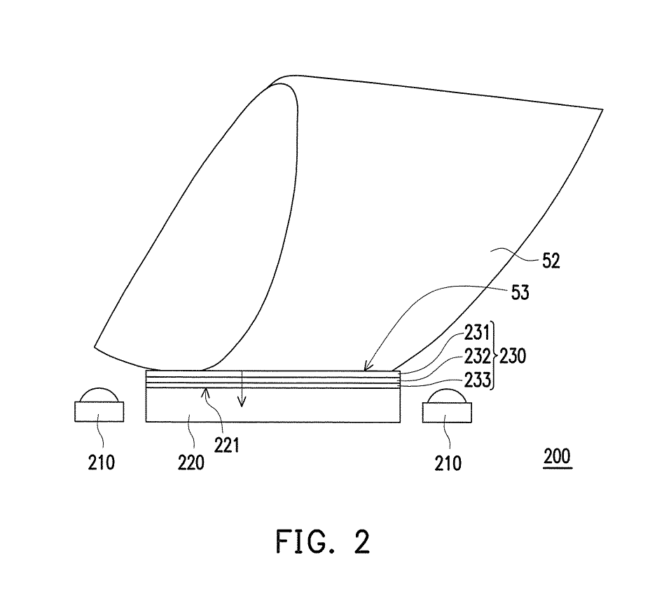

FIG. 2 is a schematic cross-sectional view illustrating a fingerprint sensing module according to a second embodiment of the disclosure. With reference to FIG. 2, the fingerprint sensing module 200 provided in the present embodiment is similar to the fingerprint sensing module 100 provided in the previous embodiment and includes a light source 210, a sensing unit 220, and an optical covering film 230. The optical covering film 230 provided herein includes optical layers 231, 232, and 233, and the optical layer 232 is located between the optical layers 231 and 233. The refractive index of the optical layer 231 is greater than the refractive index of the optical layer 232, and the refractive index of the optical layer 232 is greater than the refractive index of the optical layer 233. Hence, the optical covering film 230 can well collimate the light reflected by the surface 53 of the finger of the user 52 and simultaneously accomplish the anti-reflection effect on the sensing surface 221 of the sensing unit 220, such that the fingerprint sensing module 200 is able to accurately sense the fingerprint of the user 52.

The optical covering film 230 provided herein exposes the light source 210, and the covered area is the same as the area occupied by the sensing surface 221; therefore, the optical covering film 230 can be easily formed on the sensing unit 220.

Specifically, the optical layers 231, 232, and 233 in the present embodiment are made of a light curable material, for instance; after the sensing surface 221 is coated with the flowable light curable material, the optical layer parallel to the sensing surface 221 can be formed after the irradiation of the light. The optical layers not only can be made of the light curable material as provided in the present embodiment but also can be made of a thermosetting material in other embodiment.

To sum up, the sensing module provided herein includes the sensing unit and the optical covering film located on the sensing surface of the sensing unit. The touching surface of the optical covering film is in touch with the finger of the user, and the connecting surface of the optical covering film is connected to the sensing surface. The refractive index of the optical covering film increases from the connecting surface to the sensing surface. Hence, parts of the optical covering film close to the touching surface can achieve the optical collimating effect, and the other parts of the optical covering film close to the connecting surface can perform the anti-reflection function. Accordingly, the fingerprint sensing module can accurately receive the reflection light from each location on the finger of the user and accomplish favorable sensing effects.

Although the disclosure has been provided with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A fingerprint sensing module suitable for sensing a fingerprint of a finger of a user, the fingerprint sensing module comprising:
a sensing unit having a sensing surface;
at least one light source arranged beside the sensing unit; and
an optical covering film arranged on the sensing unit, the optical covering film covering the sensing surface and comprising:
a touching surface suitable for being in touch with the finger of the user; and
a connecting surface opposite to the touching surface, the connecting surface being connected to the sensing surface, wherein a refractive index of the optical covering film increases from the connecting surface to the touching surface, and the at least one light source is suitable for emitting light to the touching surface and irradiating the finger of the user.

2. The fingerprint sensing module as recited in claim 1, wherein the optical covering film comprises a plurality of optical layers stacked on the sensing surface along a normal vector of the sensing surface, refractive indices of the optical layers are different, and the refractive indices of the optical layers close to the touching surface are greater than the refractive indices of the optical layers close to the connecting surface.

3. The fingerprint sensing module as recited in claim 2, wherein one or more interfaces parallel to each other are formed between the optical layers, and the one or more interfaces are parallel to the sensing surface.

4. The fingerprint sensing module as recited in claim 2, wherein a material of the optical layers comprises a thermosetting material or a light curable material.

5. The fingerprint sensing module as recited in claim 1, wherein the touching surface is a smooth plane.

6. The fingerprint sensing module as recited in claim 1, wherein the at least one light source and the sensing unit are arranged on a side of the optical covering film adjacent to the connecting surface, and the connecting surface is suitable for receiving the light emitted by the at least one light source.

7. The fingerprint sensing module as recited in claim 1, wherein the optical covering film exposes the at least one light source.

8. The fingerprint sensing module as recited in claim 1, wherein the sensing unit is an image sensor.

9. The fingerprint sensing module as recited in claim 1, wherein the number of the at least one light source is plural, and the light sources are arranged on a side of the sensing unit, on a corner of the sensing unit, or on both the side and the corner of the sensing unit.

10. The fingerprint sensing module as recited in claim 1, wherein the touching surface and the connecting surface are parallel to the sensing surface.
